(19) United States
(12) Patent Application Publication
(10) Pub. No.: US 2026/0211678 A1
(43) Pub. Date: Jul. 23, 2026

(54) PROCESSOR WITH DELAYED INSTRUCTION PIPELINE FLUSH

(71) Applicant: Rivos Inc., Santa Clara, CA (US)

(72) Inventors: Brendan Ryan Sweeney, Austin, TX (US); James Nolan Hardage, Jr., Austin, TX (US)

(21) Appl. No.: 19/142,401

(22) PCT Filed: Dec. 15, 2023
(86) PCT No.: PCT/US2023/084213

§ 371 Date: Jun. 23, 2025

Related U.S. Application Data
(60) Provisional application No. 63/476,858, filed on Dec. 22, 2022.

(51) Int. Cl. G06F 9/30; G06F 9/38

(52) U.S. Cl. CPC G06F 9/30079; G06F 9/3858

(57) ABSTRACT

In a general aspect, a processor includes a plurality of control registers, an instruction processing pipeline operationally coupled with the control registers, and a pipeline flush control unit operationally coupled with the instruction processing pipeline. The pipeline flush control unit is configured to record, in response to the instruction processing pipeline completing execution of a first instruction, an indication of the first instruction. The first instruction is configured to write to a first control register of the control registers. The pipeline flush control unit is also configured to identify a second instruction in the instruction processing pipeline prior to completing execution of the second instruction, and determine, based on a set of predetermined criteria, whether the second instruction conflicts with the first instruction. If the second instruction is determined to conflict with the first instruction, the pipeline flush control unit initiates flushing of the instruction processing pipeline.

### CROSS REFERENCE TO RELATED APPLICATIONS

This application claims priority to U.S. Patent Application No. 63/476,858, filed on Dec. 22, 2022 and entitled “PROCESSOR WITH DELAYED INSTRUCTION PIPELINE FLUSH,” the disclosure of which is incorporated by reference herein in its entirety.

### TECHNICAL FIELD

This description relates to computer processing apparatuses, such as microprocessors, processors, central processing units, and the like. More specifically, this disclosure relates to computer processing apparatuses, and associated systems and methods for improving processing performance by delaying flushing of an instruction processing pipeline.

### BACKGROUND

Processors, such as processors implemented in computing systems, can include instruction execution pipelines (pipelines) for processing instructions, e.g., machine-readable instructions of a software program. For instance, processors, such as RISC-V®, processors, x86 processors, ARM® processors, Power® processors, etc., can include circuitry implementing one or more pipelines for processing instructions.

Such a pipeline can operate such that multiple instructions flow through the pipeline at different instruction processing stages, where the number of instruction processing stages of a pipeline depends on the architecture of a particular implementation. Certain instructions, such as, for example, instructions that modify control registers (CRs) of a processor can affect operation of a pipeline through which the instructions flow while being processed. For some processor architectures, such CRs can be referred to as control and status registers (CSRs). For purposes of this disclosure, such registers are collectively referred to as control registers or CRs. Other types of instructions also can affect the operation of the pipeline. For example, taken branch instructions that cause a processor to begin executing a different instruction sequence can affect the operation of the pipeline.

For purposes of this disclosure, instructions that affect operation of a pipeline are generally referred to as control register instructions, or CR instructions, though other instructions can also affect operation of a pipeline (e.g., taken branches). Further for purposes of this disclosure, instructions that do not modify CRs or change behavior of a pipeline are generally referred to as non-CR instructions. For instance, CR instructions can change how a pipeline processes instructions, such as by modifying floating point operation, modifying virtual memory operation, modifying virtualization and hypervisor state, etc. That is, CR-instructions can modify how a pipeline processes instructions by, as some examples, enabling a specific mode of operation (e.g., floating-point operation), disabling a specific mode of operation, changing control information (e.g., where instructions are fetched from in memory), etc.

Non-CR instructions that do not affect pipeline behavior can include, as some examples, arithmetic instructions, load instructions, store instructions, non-taken branch instructions, etc. For instructions of a properly ordered software program to execute correctly, changes in pipeline behavior must be applied to instructions that are processed subsequent to the change to the pipeline and before any additional changes to the pipeline due to execution of a later-received instruction. To prevent improper execution of instructions in the pipeline when its behavior is modified, where such changed behavior of the pipeline is not properly applied, conventional processors flush (i.e., empty) the pipeline after execution of each CR instruction (or other instruction modifying pipeline behavior) and then resume execution of the program using the changed behavior of the pipeline. Such pipeline flushes can negatively impact execution performance of the program by the processor, as execution cycles used for processing instructions flushed from the pipeline are wasted, as those instructions do not complete processing in the pipeline, e.g., are flushed out of the pipeline at whatever pipeline stage they are currently at when the flush occurs.

### SUMMARY

In a general aspect, a processor includes a plurality of control registers and an instruction processing pipeline operationally coupled with the plurality of control registers. The instruction processing pipeline is configured to execute a plurality of machine-readable instructions based on respective information stored in the plurality of control registers. The processor also includes a pipeline flush control unit operationally coupled with the instruction processing pipeline. The pipeline flush control unit is configured to record, in response to the instruction processing pipeline completing execution of a first instruction, an indication of the first instruction. The first instruction is configured to write to a first control register of the plurality of control registers. The pipeline flush control unit is also configured to identify a second instruction in the instruction processing pipeline prior to completing execution of the second instruction, and determine, based on a set of predetermined criteria, whether the second instruction conflicts with the first instruction. If the second instruction is determined to conflict with the first instruction, the pipeline flush control unit initiates flushing of the instruction processing pipeline.

Implementations can include one or more of the following aspects, or any combination thereof. For example, if the second instruction is determined not to conflict with the first instruction, the instruction processing pipeline can be configured to complete execution of the second instruction.

The second instruction can be configured to write to a second control register of the plurality of control registers. The pipeline flush control unit can being further configured to record an indication of the second instruction, identify a third instruction in the instruction processing pipeline prior to completing execution of the third instruction, and determine, based on the set of predetermined criteria, whether the third instruction conflicts with the first instruction or conflicts with the second instruction. If the third instruction is determined to conflict with the first instruction or the second instruction, the pipeline flush control can initiate flushing of the instruction processing pipeline. If the third instruction is determined not to conflict with the first instruction or the second instruction, the instruction processing pipeline can be further configured to complete execution of the third instruction.

The pipeline flush control unit can include an accumulator configured to store the indication of the first instruction and the indication of the second instruction. The processor can be configured to clear the accumulator in response to initiating flushing of the instruction processing pipeline.

The instruction processing pipeline can include, sequentially, a fetch stage, a decode stage, an execute stage, a memory stage, and a writeback stage. The instruction processing pipeline can include a RISC-V instruction processing pipeline.

In another general aspect, a processor includes a plurality of control registers (CRs), and an instruction processing pipeline operationally coupled with the plurality of CRs. The instruction processing pipeline is configured to execute a plurality of machine-readable instructions based on respective information stored in the plurality of CRs. The plurality of machine-readable instructions include a plurality of CR instructions and a plurality of non-CR instructions. The processor also includes a pipeline flush control unit operationally coupled with the instruction processing pipeline. The pipeline flush control unit is configured to record, in response to the instruction processing pipeline completing execution of a first instruction, an indication of the first instruction, where the first instruction is a first CR instruction of the plurality of CR instructions. The pipeline flush control unit is configured to identify a second instruction in the instruction processing pipeline prior to completing execution of the second instruction, and determine, based on a set of predetermined criteria, whether the second instruction conflicts with the first CR instruction. If the second instruction is determined to conflict with the first CR instruction, the pipeline flush control unit is configured initiate flushing of the instruction processing pipeline.

Implementations can include one or more of the following aspects, or any combination thereof. For example, if the second instruction is determined not to conflict with the first instruction, the instruction processing pipeline can be configured to complete execution of the second instruction. The second instruction can be a non-CR instruction of the plurality of non-CR instructions.

The second instruction can be a second CR instruction of the plurality of CR instructions, and the pipeline flush control unit can be configured to record an indication of the second CR instruction, and identify a third instruction in the instruction processing pipeline prior to completing execution of the third instruction. The pipeline flush control unit can be configured to determine, based on the set of predetermined criteria, whether the third instruction conflicts with the first CR instruction or the second CR instruction, and, if the third instruction is determined to conflict with the first CR instruction or the second CR instruction, initiate flushing of the instruction processing pipeline.

If the third instruction is determined not to conflict with the first CR instruction or the second instruction, the instruction processing pipeline can be configured to complete execution of the third instruction. The third instruction can be a non-CR instruction.

The pipeline flush control unit can include an accumulator configured to store the indication of the first CR instruction and the indication of the second CR instruction. The processor can be configured to clear the accumulator in response to initiating flushing of the instruction processing pipeline.

The instruction processing pipeline can include a RISC-V instruction processing pipeline.

In another general aspect, a method of processing machine-readable instructions includes completing, in an instruction processing pipeline of a processor, execution of a first instruction of the machine-readable instructions, and determining, by the processor in response to completing the execution of the first instruction, that flushing of the instruction processing pipeline can be delayed. The method further includes recording an indication of the first instruction, examining the instruction processing pipeline to identify a second instruction of the machine-readable instructions in the instruction processing pipeline prior to completing execution of the second instruction, and determining, based on a set of predetermined criteria, whether the second instruction conflicts with the first instruction. If the second instruction is determined to conflict with the first instruction, the method includes initiating flushing of the instruction processing pipeline.

Implementations can include one or more of the following aspects, or any combination thereof. For example, the first instruction can be a control register (CR) instruction, and the second instruction can be a non-CR instruction.

If the second instruction is determined not to conflict with the first instruction, the method can further include completing execution of the second instruction.

The first instruction can be a first control register (CR) instruction, and the second instruction can be a second CR instruction. The method can include recording an indication of the second CR instruction, identifying a third instruction of the machine-readable instructions in the instruction processing pipeline prior to completing execution of the third instruction, and determining, based on the set of predetermined criteria, whether the third instruction conflicts with the first CR instruction or conflicts with the second CR instruction. If the third instruction is determined to conflict with the first CR instruction or the second CR instruction, the method can include initiating flushing of the instruction processing pipeline.

The third instruction can be a non-CR instruction.

If the third instruction is determined not to conflict with the first CR instruction or the second CR instruction, the method can include completing execution of the third instruction.

In another general aspect, a processor includes a plurality of control registers, and an instruction processing pipeline operationally coupled with the plurality of control registers. The instruction processing pipeline is configured to execute a plurality of machine-readable instructions based on respective information stored in the plurality of control registers. The processor further includes a pipeline flush control unit operationally coupled with the instruction processing pipeline. The pipeline flush control unit and the instruction processing pipeline are configured to record, in response to the instruction processing pipeline completing execution of a first instruction, an indication of the first instruction. The first instruction is configured to write to a first control register of the plurality of control registers. The pipeline flush control unit and the instruction processing pipeline are further configured to identify a second instruction in the instruction processing pipeline prior to completing execution of the second instruction, determine, based on a set of predetermined criteria, that the second instruction does not conflict with the first instruction, and complete execution of the second instruction. The pipeline flush control unit and the instruction processing pipeline are further configured to identify a third instruction in the instruction processing pipeline, determine, based on the set of predetermined criteria, that the third instruction conflicts with the first instruction, and, in response to the determination that the third instruction conflicts with the first instruction, initiate flushing of the instruction processing pipeline prior to completing execution of the third instruction.

### BRIEF DESCRIPTION OF THE DRAWINGS

FIG. 1 is a block diagram illustrating an example processor.

FIG. 2 is a block diagram illustrating an example instruction processing pipeline that can be included in the processor of FIG. 1.

FIG. 3 is a block diagram illustrating an example pipeline flush control unit that can be included in the processor of FIG. 1.

FIGS. 4A and 4B are tables illustrating example instruction group classification conflicts and conflict criteria for, respectively, control register (CR) instructions and non-CR instructions.

FIGS. 5A and 5B are timing diagrams illustrating examples of flushing of an instruction processing pipeline based on the example instruction classifications and conflict criteria of FIGS. 4A and 4B.

FIG. 6 is a flowchart illustrating a method for delayed flushing of an instruction processing pipeline.

FIG. 7 is a diagram illustrating an example architecture of a computing device, which can be used to implement aspects according to the present disclosure.

Like reference symbols in the various drawings indicate like and/or similar elements.

### DETAILED DESCRIPTION

This disclosure relates to computer processing apparatuses, such as processors, microprocessors, central processing units, graphics processing units, tensor processing units, and accelerators, etc. (hereafter “processor(s)”), and related systems and methods, that can improve processor execution performance by reducing occurrence of instruction processing pipeline flushes. For instance, techniques described herein include storing a set of conflict criteria, using the criteria to identify interfering instructions, and flushing an instruction processing pipeline when interfering instructions are identified but permitting processing to continue without pipeline flushes in the absence of interfering instructions. In some implementations, the conflict criteria can be predetermined based on an analysis of a given processor's instruction set and its control registers (CRs). In some implementations, the conflict criteria can be determined by architects or implementers of the instructions set used by the processor

So long as interfering instructions are not identified in an instruction processing pipeline (e.g., from instructions that are at different stages of the instruction processing pipeline at the same time), execution of instructions can continue until a conflict is identified, and a flush of the instruction processing pipeline can then be initiated. Accordingly, compared with previous approaches where a flush is initiated after completing execution of each CR instruction, a number of instruction processing pipeline flushes, e.g., when executing a given set of instructions, can be reduced and execution performance can be improved. For example, for a sequence of instructions that includes three CR instructions that are not interfering and a subsequent instruction that is interfered with by one or more of those previous non-interfering CR instructions, a number of instruction processing pipeline flushes can be reduced from three to one, as compared to prior approaches that initiate an instruction processing pipeline flush after each CR instruction completes execution.

In some implementations, different instructions can be classified in groups, and conflict criteria between the instructions can be determined and assigned based on the groups. For instance, CR instructions can be grouped based on respective CRs that they can write to. For instance, CR instructions that write to CRs affecting virtual memory operation can be classified in a first CR instruction group. CR instructions that write to CRs affecting a virtualization and hypervisor state for a processor can be classified in a second CR instruction group. CR instructions that write to CRs affecting floating point arithmetic can be classified in a third CR instruction group. In the example implementations described herein, CR instructions of a given classification can be presumed to not be mutually interfering, i.e., to not interfere with one another. Non-CR instructions can also be classified into non-CR instruction groups. For example, floating point arithmetic instructions can be classified in a first non-CR instruction group, and integer arithmetic operations can be in a second non-CR instruction group. Other types of non-CR instructions can be classified in other respective non-CR instruction groups.

These classification groupings are provided by way of example, and for purposes of illustration. Depending on the implementation, additional, fewer, and/or different group classifications can be used. For instance, CR instructions that require an immediate flush of an associated instruction processing pipeline can be classified in an additional CR instruction group. In some implementations, such CR instructions can include CR instructions that write to a CR that controls the flushing of an instruction processing pipeline, CR instructions that write to CRs used for debug operations, and so forth. Also, in some implementations, non-CR instructions that perform memory loads or stores can be classified in a respective group. Again, other instruction classification groupings for both CR instructions and non-CR instructions are possible. In some implementations, instructions of a given group can each include an indication, e.g., a bit field, indicating their respective group. In other implementations, other approaches, such as a look-up-table, or an indexed list can be used to determine an instruction's respective group.

In some implementations, conflict criteria can include, for each CR instruction group, an indication of interfering (other) CR instruction groups. For instance, in the example above, the first CR instruction group (virtual memory) can be indicated as interfering with the second CR instruction group (virtualization and hypervisor) and interfering with the third CR instruction group (floating point). Likewise, the second CR instruction group and the third CR instruction group can both be indicated as interfering with the first CR instruction group, although there is no conflict between instructions of the second CR instruction group and instructions of the third CR instruction group. In this example, the first CR instruction group can be referred to as mutually interfering with the second CR instruction group and the third CR instruction group, and vice versa.

For non-CR instruction groups, the conflict criteria can include, for each non-CR instruction group, an indication of CR instruction groups that interfere with instructions of that non-CR instruction group. For instance, a non-CR instruction group for floating point arithmetic instructions can be indicated as being interfered with by the second CR instruction group described above (floating point CR instructions). As with the instruction group classifications, the conflict criteria can be respectively included (e.g., as bit fields) in each instruction, or can be listed in a look-up-table or indexed list, as some examples.

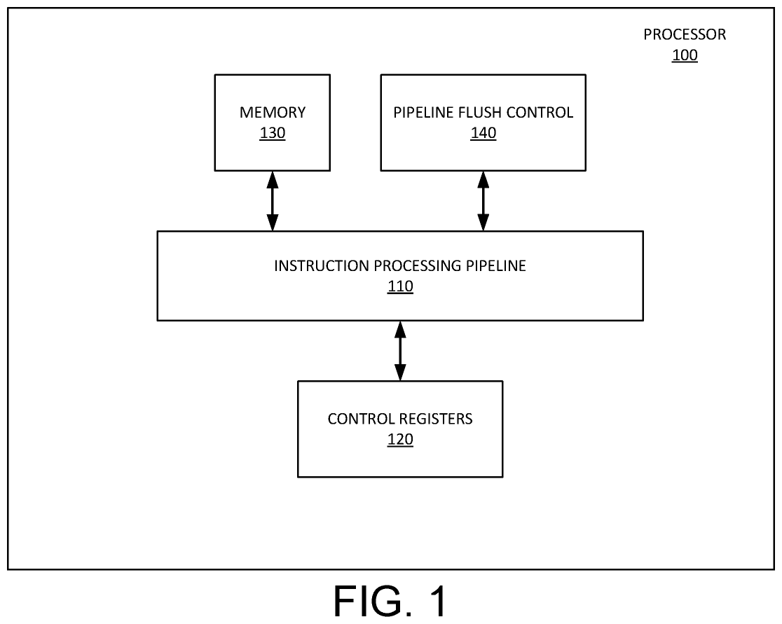

FIG. 1 is a block diagram illustrating an example processor 100. The processor 100 can, using the techniques described herein, reduce occurrence of instruction processing pipeline flushes by delaying such flushes based on detection of interference between instructions. For instance, the processor 100 can be configured to delay an instruction processing pipeline flush based on an absence of interference between instructions that are executed by the processor 100. Accordingly, implementations of the processor 100 can improve execution performance over prior processor implementations that initiate an instruction processing pipeline flush after completion of each CR instruction. The processor 100 is shown by way of example, and for purposes of illustration. In some implementations, the techniques described herein can be implemented in processors having other configurations.

As shown in FIG. 1, the processor 100 includes an instruction processing pipeline 110, CRs 120, memory 130 and a pipeline flush control unit 140. The CRs 120, the memory 130 and the pipeline flush control unit 140 are operationally coupled (functionally coupled, functionally connected, etc.) with the instruction processing pipeline 110. In some implementations, one or more elements of the processor 100 can be integrated with each other. For instance, the memory 130, or a portion thereof, can be included in the instruction processing pipeline 110. In some implementations, the pipeline flush control unit 140 can be integrated with the instruction processing pipeline 110. That is, in such implementations, the functionality of the pipeline flush control unit 140 can be implemented by the instruction processing pipeline 110.

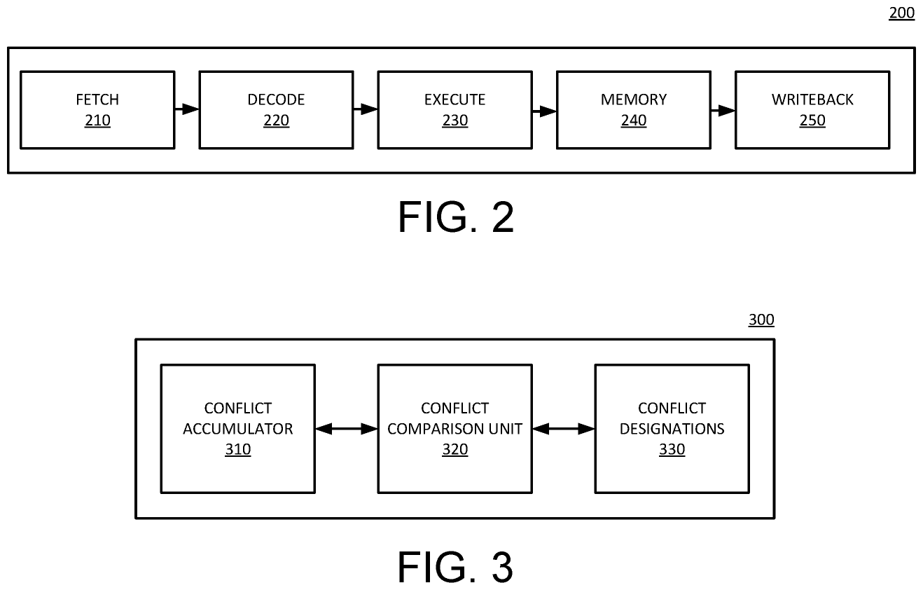

The instruction processing pipeline 110 can be a sequential, multi-stage instruction processing pipeline that includes a plurality of sequential stages. Examples of such instruction processing pipelines are described further below with respect to FIG. 2. The instruction processing pipeline 110 can be configured to execute machine-readable instructions (e.g., instructions of a software program stored in the memory 130). The instructions can include CR instructions and non-CR instructions. Such instruction execution can be based, in part, on control and status information stored in the CRs 120, where the information in the CRs can be modified, e.g., written to, by the CR instructions.

In this example, using the techniques described herein, the pipeline flush control unit 140 can determine whether instructions being processed in the instruction processing pipeline 110 could, or do, mutually interfere with one another. e.g., whether a CR instruction can interfere with later-executed CR instructions or with later-executed non-CR instructions. If the pipeline flush control unit 140 determines that interference between instructions being processed in the instruction processing pipeline 110 will occur, the pipeline flush control unit 140 can initiate a flush of the instruction processing pipeline 110 to remove all instructions currently being processed in the instruction processing pipeline 110 and prevent that interference. If the pipeline flush control unit 140 determines that instructions being processed in the pipeline do not interfere, the instruction processing pipeline 110 can continue processing instructions until an interference is identified with an instruction that is in-process in the instruction processing pipeline 110 (e.g., has not yet completed execution), or until a specific request to flush the instruction processing pipeline 110 is made, e.g., by writing a respective CR of the CRs 120, and then initiate a flush.

FIG. 2 is a block diagram illustrating an example instruction processing pipeline 200 that can be included in the processor of FIG. 1. For instance, the instruction processing pipeline 200 can implement the instruction processing pipeline 110 of the processor 100. As shown in FIG. 2, the instruction processing pipeline 200 includes five sequential stages for processing machine-readable instructions, e.g., CR instructions and non-CR instructions. These stages include a fetch stage 210, a decode stage 220, an execute stage 230, a memory stage 240, and a writeback stage 250. Accordingly, in this example, the instruction processing pipeline 200 can have five instructions that are at various stages of execution by the instruction processing pipeline 200. The fetch stage 210 can fetch instructions from memory, such as an instruction cache memory. The decode stage 220 may perform one or more of decoding fetched instructions to generate one or more respective micro-operations, detecting instruction classes of fetched instructions, or isolating source or destination registers for fetched instructions. The execute stage 230 can execute the operation encoded by the instructions or execute the micro-operations generated by the decode stage 220. The memory stage 240 can perform memory loads and/or stores associated with a respective instruction. The writeback stage 250 can write respective results of instructions to a register file, which can include CRs of a processor.

Execution of a given instruction in the instruction processing pipeline 200 is not complete until processing of the instruction by the writeback stage 250 has been performed. Accordingly, if the writeback stage 250 completes processing of a CR instruction, the execution of instructions at earlier stages of the instruction processing pipeline 200 (i.e., that will complete execution later in time than the CR instruction for which the writeback is performed) can be affected, e.g., interfered with, by that CR instruction. For instance, if there is mutual interference between instructions that are at earlier stages of the instruction processing pipeline 200 when the CR instruction is completed, those earlier instructions may not execute properly.

For instance, interfering instructions can be defined as instructions where completing execution of one instruction will modify how a pipeline processes that instruction or another instruction. By way of example, if a CR instruction completes writeback and modifies floating point operation of a pipeline, any in-process (i.e., partially processed) floating point arithmetic instructions in the pipeline may not be processed in accordance with that modification throughout the entire pipeline, and would be improperly processed if allowed to reach the writeback stage. That is, it is typically presumed that instructions of a software program are executed in accordance with an associated sequential program flow, and that all prior instructions in the sequential flow complete processing before a next instruction completes its processing. However, due to the parallel and sequential processing of instructions by the instruction processing pipeline 200 (e.g., where instructions pass through successive stages of the pipeline and different instructions are processed simultaneously in parallel by the different stages), if operation of the instruction processing pipeline is modified due to the execution of a CR instruction, the changed operation of the pipeline can affect instructions that follow the CR instruction in the sequence and still being processed by one or more earlier pipeline stages. Therefore the later instructions may not be properly processed. To mitigate this issue, while also promoting efficient use of processing cycles, the instruction processing pipeline 200 can be flushed in response to interfering instructions being identified, while flushing of the instruction processing pipeline 200 can be delayed when interfering instructions are not identified.

In some implementations, such as the example of FIG. 1, the instruction processing pipeline 200 can be operationally coupled with a pipeline flush control unit, such as the pipeline flush control unit 140 of the processor 100. In other implementations, the elements of the pipeline flush control unit 140 can be included in, or integrated with, the instruction processing pipeline 200, rather than being implemented in a separate unit. For instance, in some implementations, the instruction processing pipeline 200 can be configured to implement the functionality of a pipeline flush control unit, such as the pipeline flush control unit 140 of FIG. 1 and/or the pipeline flush control unit 300 of FIG. 3.

In some implementations, the instruction processing pipeline 200 can be an instruction processing pipeline of a RISC-V® processor or another instruction processing pipeline 200 and can include fewer stages, different stages, or additional stages. For instance, in some implementations, an instruction processing pipeline can include a fetch stage, an execute stage, and a writeback stage. In some implementations, an instruction processing pipeline can include an x86 instruction processing pipeline.

FIG. 3 is a block diagram illustrating an example pipeline flush control unit 300 that can be included in the processor of FIG. 1. For instance, the pipeline flush control unit 300 can implement the pipeline flush control unit 140 of the processor 100. In some implementations, the pipeline flush control unit 300 can be operationally coupled with an instruction processing pipeline, such as the instruction processing pipeline 110 of the processor 100, or the instruction processing pipeline 200 of FIG. 2. In other implementations, as noted above, the elements of the pipeline flush control unit 300 can be included in, integrated with, an instruction processing pipeline, rather than being implemented in a separate unit. For instance, in some implementations, an instruction processing pipeline can be configured to implement the functionality of the pipeline flush control unit 300.

In the example of FIG. 3, the pipeline flush control unit 300 includes a conflict accumulator 310, a conflict comparison unit 320, and a conflict designations block 330. In this example, the conflict accumulator 310 can be configured to record (store) indications of instructions, e.g., CR instructions, that have completed processing (e.g., have been processed by a writeback stage of an associated instruction processing pipeline) for which flushing of an associated instruction processing pipeline can be delayed, e.g., an instruction that does not require an immediate flush of the pipeline. That is, the conflict accumulator 310 can be used to record one or more CR instruction classification groups for CR instructions that have completed processing, and the conflict comparison unit 320 can compare the stored CR instruction indications to instruction classifications of subsequent instructions. If a match with one of the conflict criteria included in the conflict designations block 330 is identified by the conflict comparison unit 320, then a flush of the pipeline is initiated.

In the example of FIG. 3, the conflict comparison unit 320 can be configured to identify instructions that are in-process in an instruction processing pipeline and determine whether those in-process instructions mutually conflict with the CR instruction records included in the conflict accumulator 310. For instance, the conflict comparison unit 320 can determine a group classification for an in-process instruction by inspecting the in-process instructions in the instruction processing pipeline, such as by reading respective instruction information from one or more stages of the pipeline. The conflict comparison unit 320 can then identify, from the conflict designations block 330, what instruction group classifications are designated as mutually interfering with the group classification of the in-process instruction. The conflict comparison unit 320 can then compare those mutually interfering instruction classes from the conflict designations block 330 with any instruction group classification indications recorded in the conflict accumulator 310. That is, if the conflict accumulator 310 includes a recorded indication of a completed instruction with an instruction classification designated in the conflict designations block 330 for the in-process instruction, the conflict comparison unit 320, can initiate flushing of the associated instruction processing pipeline to remove the in-process instruction, as well as other in-process instructions. The instruction processing pipeline can then fetch a next instruction in accordance with the program flow and any control or state changes made in corresponding CRs.

In example implementations, initiating a flush of an instruction processing pipeline can also result in any stored instruction group classification indications being cleared from the conflict accumulator 310. Further, in some implementations, once instructions that are in-process in an associated instruction processing pipeline when a CR instruction completes writeback have also completed writeback processing, without a flush of the instruction processing pipeline, the indication of that CR instruction can be removed from the conflict accumulator 310. That is, the indication of the completed CR instruction recorded in the accumulator 310 can be removed, as there is no longer a risk of conflict with instructions that later enter the instruction processing pipeline, e.g., are fetched, after writeback processing of the completed CR instruction because those later entering instructions would be processed with the change from the CR instruction.

In some implementations, as noted above, instruction group classifications and conflict designations can be respectively included in instructions, e.g., in corresponding fields of the instructions. For instance, such fields can be defined as part of a corresponding instruction set architecture (ISA), or as an extension to a corresponding ISA for a given processor implementation. In such implementations, the conflict designations block 330 of the pipeline flush control unit 300 can be omitted, and the conflict comparison unit 320 can compare instruction group classifications and/or conflict designations included in such fields of in-process instructions with indications included in the conflict accumulator 310.

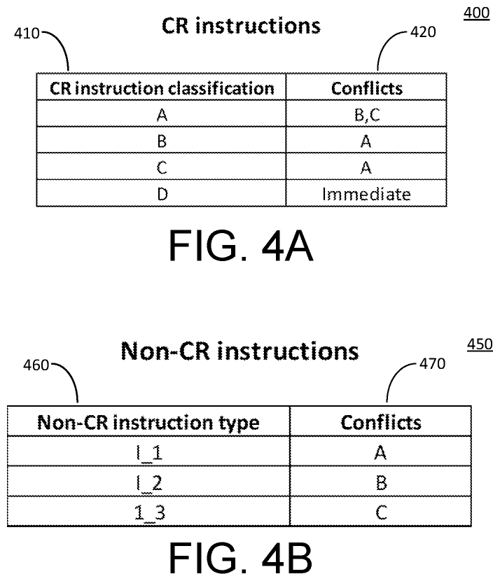

FIGS. 4A and 4B are tables illustrating example instruction group classifications and conflict criteria for, respectively, CR instructions (FIG. 4A, table 400) and non-CR instructions (FIG. 4B, table 450). In some implementations, different instruction group classifications and/or different conflict criteria than those described in this example can be used. In some implementations, the instruction classifications and conflict criteria shown in the table 400 and the table 450 can be stored in a pipeline flush control unit, e.g., in the conflict designations block 330 of the pipeline flush control unit 300 and used to determine instructions conflicts that result in flushing of an associated instruction processing pipeline.

Referring to FIG. 4A, column 410 of the table 400 includes different CR instruction classifications A, B, C, and D, and column 420 includes respective CR instruction classifications for CR instructions that mutually interfere with CR instructions with the classifications of corresponding rows of column 410. That is, column 420 includes respective conflict criteria for the CR instruction classifications of column 420. As described herein, these CR instruction classifications and conflict criteria can be predetermined based on a particular processor implementation. In some implementations, different and/or additional instruction group classifications and/or conflict criteria than those described herein can be used.

Using the examples of CR instruction classifications discussed above with further reference to the table 400, CR instruction classification A can be associated with CR instructions that modify CRs related to virtual memory operation. CR instruction classification B can be associated with CR instructions that modify CRs related to virtualization and hypervisor state. CR instruction classification C can be associated with CR instructions that modify CRs related to floating point arithmetic operation. CR classification D can be associated with CRs instructions that modify CRs which result in an immediate flush of an associated instruction processing pipeline, such as CRs used to request an instruction pipeline flush, CRs related to debug operations, etc. As shown in column 420, conflict criteria for CR instruction classification A indicates that instructions included in that classification mutually interfere with CR instructions with CR instruction classifications B and C. Likewise, respective conflict criteria for CR instruction classifications B and C indicate that instructions included in those classifications mutually interfere with CR instructions with CR instruction classification A.

Referring to FIG. 4B, column 460 of the table 450 includes non-CR instruction classifications I_1, I_2 and I_3, and column 470 includes respective CR instruction classifications for CR instructions that interfere with the non-CR instructions included in the respective classifications of column 460. That is, column 470 includes respective conflict criteria for the non-CR instruction classifications of column 460. As described herein, these non-CR instruction classifications and conflict criteria can be predetermined based on a particular processor implementation. In this example, non-CRs instructions of classification I_1 have conflict criteria (e.g., are interfered with) by CR instructions with classification A. That is, non-CR instructions with the classification I_1 can be interfered with, e.g., may not properly execute, because of modifications made to CRs by CR instructions of classification A. For instance, in this example, CR instructions related to virtual memory operation (classification A in the table 400) are indicated as interfering with non-CR instructions of classification I_1. Such non-CR instructions can include, for example, particular loads, stores, and instruction fetches.

As also shown in FIG. 4B, in this example, non-CRs instructions of classification I_2 have conflict criteria (e.g., are interfered with) indicating interference with CR instructions with classification B. That is, non-CR instructions with the classification I_2 can be interfered with, e.g., may not properly execute, because of modifications made to CRs by CR instructions of classification B. For instance, in this example, CR instructions related to virtualization and hypervisor state (classification B in the table 400) are indicated as interfering with non-CR instructions of classification I_2. Such non-CR instructions can include, for example, instructions that attempt to read from guest memory or state.

As further shown in FIG. 4B, in this example, non-CRs instructions of classification I_3 have conflict criteria (e.g., are interfered with) indicating interference with CR instructions with classification C. That is, non-CR instructions with the classification I_3 can be interfered with, e.g., may not properly execute, because of modifications made to CRs by CR instructions of classification C. For instance, in this example, CR instructions related to floating point operation (classification C in the table 400) are indicated as interfering with non-CR instructions of classification I_3. Such non-CR instructions can include floating point arithmetic instructions.

The instruction classifications and conflict criteria shown in FIGS. 4A and 4B are given by way of example, and for purposes of illustration. In some implementations, other classifications and/or conflict criteria are possible. For example, CR instructions related to virtual memory operation can interfere with CR instructions and/or non-CR instructions other than those shown in the table 400 and the table 450. Also, other classifications of instructions, fewer classifications of instructions, additional classifications of instructions, other conflict criteria, fewer conflict criteria, additional conflict criteria, etc. could be used in some implementations. Furthermore, in some implementations, the conflict criteria can be dynamic, in that they may depend on a state of the processor. For example, if the processor is operating in a mode in which virtual memory is disabled, changes to the virtual memory (except for enabling it) would not need to generate a flush, but if the processor is operating in a mode in which virtual memory is enabled, changes to the virtual memory would need to generate a flush.

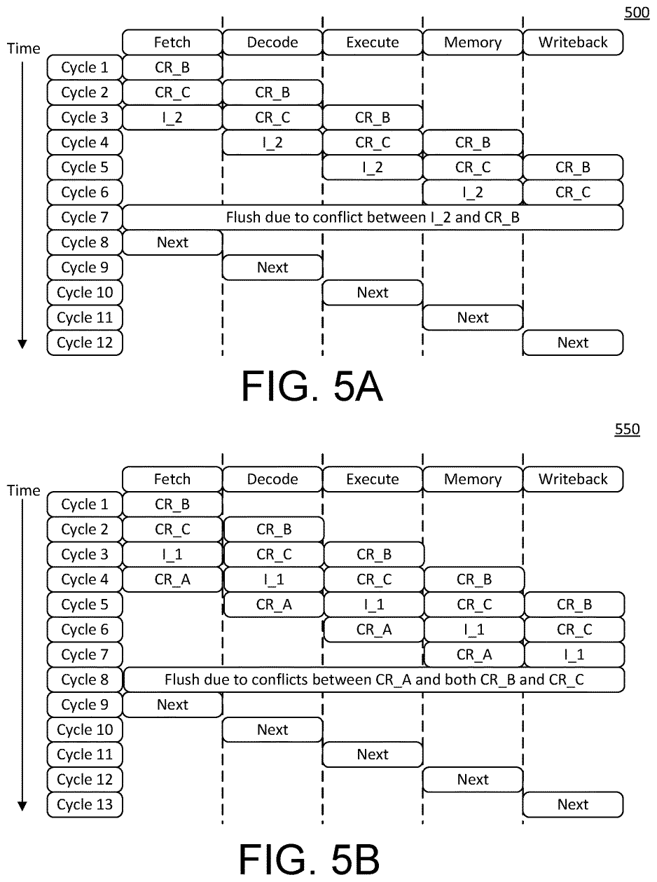

FIGS. 5A and 5B are timing diagrams illustrating examples of delayed flushing of an instruction processing pipeline. As described herein, such delayed instruction processing pipeline flushing can improve processor performance by reducing occurrences of instruction pipeline flushing as compared to prior approaches. In this example, instruction pipeline flushing can be performed based on the example instruction classifications and conflict criteria of FIGS. 4A and 4B, such as when executed in the instruction processing pipeline 200 of FIG. 2. Accordingly, the examples of FIGS. 5A and 5B illustrate instructions proceeding sequentially through a fetch stage, a decode stage, an execute stage, a memory stage, and a writeback stage.

In the examples of FIGS. 5A and 5B time increments moving from top to bottom, as is indicated in the respective timing diagrams. For purposes of illustration, each increment of instruction processing, as well as flushing of the instruction processing pipeline, is shown as occurring in a single processor cycle. In some implementations, these increments of instruction processing and/or instruction pipeline flushing can include, or can be performed over multiple processor cycles. The sequences of the timing diagrams of FIGS. 5A and 5B presume that an associated instruction processing pipeline is clear, e.g., has just been flushed or is beginning execution of instructions at the beginning of a software program.

Referring to FIG. 5A, with additional reference to at least FIGS. 4A and 4B, a timing diagram 500 illustrates an example of processing a CR instruction of classification B (CR_B), a CR instruction of classification C (CR_C), and a non-CR instruction with a classification of I_2 (I_2). As shown in FIG. 5A, at cycle 1, CR_B is fetched. At cycle 2, CR_B proceeds to the decode stage and CR_C is fetched. At cycle 3, CR_B proceeds to the execute stage, CR_C proceeds to the decode stage, and I_2 is fetched. At cycle 4, CR_B proceeds to the memory stage, CR_C proceeds to the execute stage, and I_2 proceeds to the decode stage. While not shown in FIG. 5A, additional instructions could be fetched at cycle 4, as well as at cycles 5 and 6, and similarly proceed through an associated instruction processing pipeline, e.g., the instruction processing pipeline 200.

At cycle 5, CR_B proceeds to the writeback stage and completes execution. As CR_B does not require an immediate flush (as with CR instructions of classification D), and is the first instruction in this sequence to reach the writeback stage, flushing of the instruction processing pipeline can be delayed. An indication of the completion of CR_B can be recorded at cycle 5, e.g., in a conflict accumulator. Also, at cycle 5, the instruction processing pipeline can be examined to identify CR_C as the next instruction that will proceed to the writeback stage. As CR_B and CR_C do not mutually interfere (conflict), at cycle 6, CR_C proceeds to the writeback stage and completes execution, and an indication of the completion of CR_C can also be recorded, e.g., in a conflict accumulator. Also, at cycle 6, the instruction processing pipeline can be examined to identify I_2 as the next instruction that will proceed to the writeback stage. As CR_B interferes (conflicts) with I_2, at cycle 6, a flush of the instruction processing pipeline is initiated, e.g., by a pipeline flush control unit, and the sequence proceeds to cycle 8, where the instruction processing pipeline is flushed. That is, in some implementations, the interference of CR_B with I_2 can be determined by a pipeline flush control unit and the indication of CR_B in a conflict accumulator, e.g., by the conflict accumulator 310, the conflict comparison unit 320 and the conflict designations block 330 of the pipeline flush control unit 300. In this example, initiating flushing of the instruction processing pipeline can also result in previously recorded conflicts being cleared, e.g., from an accumulator.

At cycle 8, a next instruction is fetched and proceeds through the instruction processing pipeline. The next instruction fetched at cycle 8 can be based on an associated program flow, as well control or status information modified by CR_B and/or CR_C. In some implementations, the next instruction could be I_2, but could be a different instruction. Also, while not shown in FIG. 5A, additional instructions could be fetched at cycles 9 to 12 of the timing diagram 500, and begin sequentially proceeding through the associated instruction processing pipeline.

Referring to FIG. 5B, with additional reference to at least FIGS. 4A and 4B, a timing diagram 550 illustrates an example of processing a CR instruction of classification B (CR_B), a CR instruction of classification C (CR_C), a non-CR instruction with a classification of I_1 (I_1), and a CR instruction of classification A (CR_A). As shown in FIG. 5B, at cycle 1, CR_B is fetched. At cycle 2, CR_B proceeds to the decode stage and CR_C is fetched. At cycle 3, CR_B proceeds to the execute stage, CR_C proceeds to the decode stage, and I_1 is fetched. At cycle 4, CR_B proceeds to the memory stage, CR_C proceeds to the execute stage, I_1 proceeds to the decode stage, and CR_A is fetched. While not shown in FIG. 5A, additional instructions could be fetched at cycle 5, as well as at cycles 6 and 7, and similarly proceed through the instruction processing pipeline, e.g., the instruction processing pipeline 200.

At cycle 5, CR_B proceeds to the writeback stage and completes execution. As CR_B does not require an immediate flush, and is the first instruction in this sequence to reach the writeback stage, flushing of the instruction processing pipeline can be delayed. An indication of the completion of CR_B can be recorded at cycle 5, e.g., in a conflict accumulator. Also, at cycle 5, the instruction processing pipeline can be examined to identify CR_C as the next instruction that will proceed to the writeback stage. As CR_B and CR_C do not mutually interfere (conflict), at cycle 6, CR_C proceeds to the writeback stage and completes execution, and an indication of the completion of CR_C can also be recorded, e.g., in a conflict accumulator. Also, at cycle 6, the instruction processing pipeline can be examined to identify I_1 as the next instruction that will proceed to the writeback stage.

As CR_B and CR_C do not interfere (conflict) with I_1, at cycle 7, I_1 proceeds to the writeback stage and completes execution. In this example, as I_1 is a non-CR instruction, an indication of it completing execution may not be recorded, as no control or status information may be modified by I_1. Also, at cycle 7, the instruction processing pipeline can be examined to identify CR_A as the next instruction that will proceed to the writeback stage. As CR_A mutually interferes (conflicts) with both CR_B and CR_C, at cycle 7, a flush of the instruction processing pipeline is initiated, e.g., by a pipeline flush control unit, and the sequence proceeds to cycle 8, where the instruction processing pipeline is flushed. That is, in some implementations, the mutual interference of CR_A with CR_B and CR_C can be determined by a pipeline flush control unit and the indications of CR_B and CR_C in a conflict accumulator, e.g., by the conflict accumulator 310, the conflict comparison unit 320 and the conflict designations block 330 of the pipeline flush control unit 300. In this example, as with the example of FIG. 5A, initiating flushing of the instruction processing pipeline can also result in previously recorded conflicts being cleared, e.g., from an accumulator.

At cycle 9, a next instruction is fetched and proceeds through the instruction processing pipeline. The next instruction fetched at cycle 9 can be based on an associated program flow, as well control or status information modified by CR_B and/or CR_C. In some implementations, the next instruction could be CR_A, but could be a different instruction. Also, while not shown in FIG. 5A, additional instructions could be fetched at cycles 10 to 13 of the timing diagram 500, and begin sequentially proceeding through the associated instruction processing pipeline.

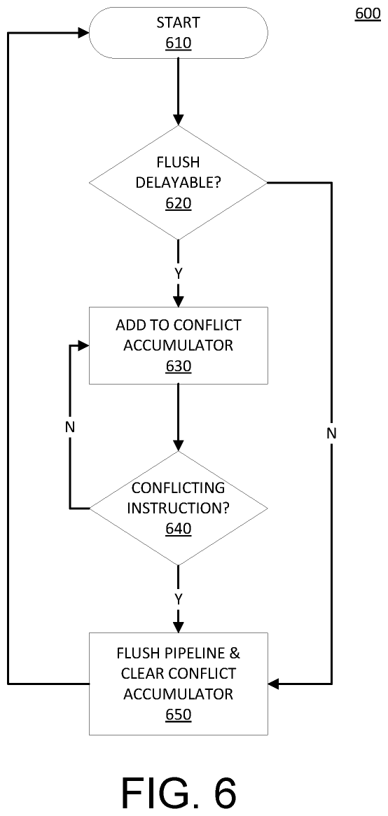

FIG. 6 is a flowchart illustrating a method 600 for delayed flushing of an instruction processing pipeline. In some implementations, the method 600 can be implemented using the apparatuses and techniques described herein. As shown in FIG. 6, the method 600 starts at block 610. At block 610, an instruction pipeline in which the method 600 is being implemented is clear (e.g., is not currently processing any instructions). In the method 600, execution of instructions can begin until a CR instruction is encountered. At block 620, a determination can be made whether flushing of the instruction processing pipeline can be delayed, e.g., based on associated instruction classifications and conflict criteria. If the CR instruction does not permit delaying flushing of the instruction pipeline, e.g., is a CR instruction of classification D in FIG. 4A, the method proceeds to block 650 and the instruction processing pipeline is flushed. The method 600 then returns to the start at block 610.

If, at block 620, it is determined that flushing of the instruction processing pipeline can be delayed, e.g., the CR instruction is of classification A, B or C of FIG. 4A, the method 600 proceeds to block 630 and an indication of the CR instruction is added to (recorded in) a conflict accumulator, e.g., the conflict accumulator 310 of the pipeline flush control unit 300. The method then proceeds to block 640 and subsequent instructions are identified and determinations of whether or not a conflict has been encountered based on respective conflict criteria and indications recorded in the conflict accumulator, e.g., using the pipeline flush control unit 300. If no conflict is identified, instruction processing can continue and the method can return to block 630. At block 630, further indications (for non-interfering CR instructions) can be added to the conflict accumulator.

If a conflict is identified at block 640, the method 600 can proceed to block 650, where the instruction processing pipeline can be flushed and the accumulator can be cleared. After completing processing block 650, the method 600 returns to the start (clear instruction processing pipeline) at block 610.

In some implementations, if a CR instruction does not modify a previous value stored in an associated CR, flushing that may otherwise be initiated based on corresponding conflict criteria can be delayed, as no interference may result from an unchanged value being written to a CR. In such implementations, the previous value of the CR can be retrieved (e.g., from the CR or a memory location) prior to writing the CR. If the retrieved value matches the value to be written, flushing that would otherwise be initiated can be delayed. Furthermore, a CR instruction that writes a value that is the same as a value previously stored in a corresponding CR may not be recorded, e.g., in a conflict accumulator, as no interference may result from writing that value to a corresponding CR.

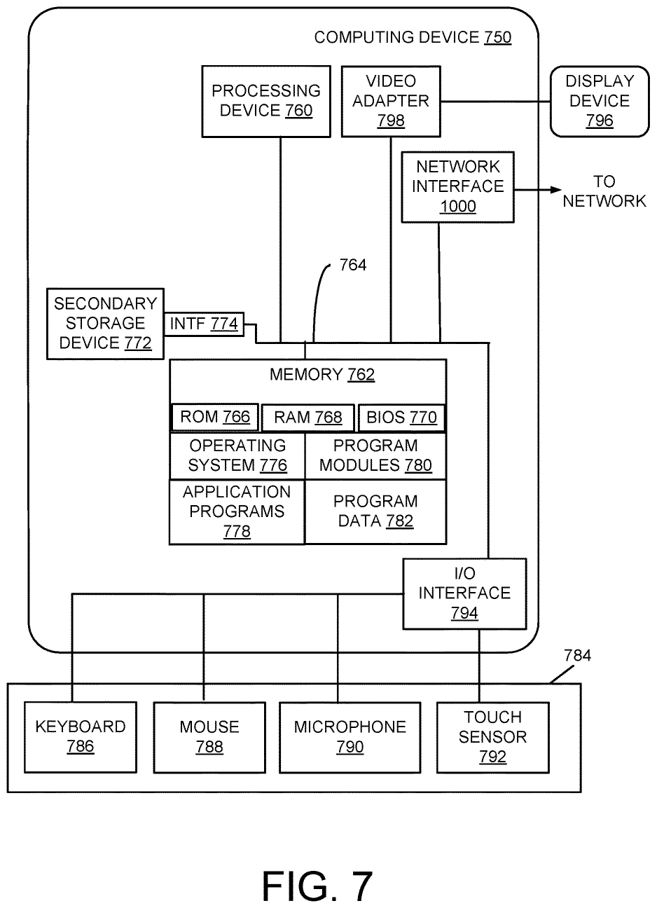

FIG. 7 illustrates an example architecture of a computing device 750 that can be used to implement aspects of the present disclosure, including any of the plurality of computing devices described herein, such as a computing device including the processor 100, or any other computing devices that may be utilized in the various possible embodiments. The computing device illustrated in FIG. 7 can be used to execute and operating system, application programs and software modules, such as described herein.

The computing device 750 includes, in some embodiments, at least one processing device 760, such as a central processing unit (CPU). A variety of processing devices are available from a variety of manufacturers, for example, Intel or Advanced Micro Devices. In this example, the computing device 750 also includes a system memory 762, and a system bus 764 that couples various system components including the system memory 762 to the processing device 760. The system bus 764 is one of any number of types of bus structures including a memory bus, or memory controller; a peripheral bus; and a local bus using any of a variety of bus architectures.

Examples of computing devices suitable for the computing device 750 include a server computer, an edge computer, a desktop computer, a laptop computer, a tablet computer, a mobile computing device (such as a smart phone, an iPod® or iPad® mobile digital device, or other mobile devices), or other devices configured to process digital instructions.

The system memory 762 includes read only memory 766 and random access memory 768. A basic input/output system 770 containing the basic routines that act to transfer information within computing device 750, such as during start up, is typically stored in the read only memory 766.

The computing device 750 also includes a secondary storage device 772 in some embodiments, such as a hard disk drive, for storing digital data. The secondary storage device 772 is connected to the system bus 764 by a secondary storage interface 774. The secondary storage device 772 and its associated computer readable media can provide nonvolatile storage of computer readable instructions (including application programs and program modules), data structures, and other data for the computing device 750.

Although the example environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory computer-readable media. Additionally, such computer readable storage media can include local storage or cloud-based storage.

A number of program modules can be stored in secondary storage device 772 or system memory 762, including an operating system 776, one or more application programs 778, other program modules 780 (such as the software engines described herein), and program data 782. The computing device 750 can utilize any suitable operating system, such as Microsoft Windows™, Google Chrome™ OS or Android, Apple OS, Unix, or Linux and variants and any other operating system suitable for a computing device. Other examples can include Microsoft, Google, or Apple operating systems, or any other suitable operating system used in tablet computing devices.

In some embodiments, a user provides inputs to the computing device 750 through one or more input devices 784. Examples of input devices 784 include a keyboard 786, mouse 788, microphone 790, and touch sensor 792 (such as a touchpad or touch sensitive display). Other embodiments include other input devices 784. The input devices are often connected to the processing device 760 through an input/output interface 794 that is coupled to the system bus 764. These input devices 784 can be connected by any number of input/output interfaces, such as a parallel port, serial port, game port, or a universal serial bus. Wireless communication between input devices and the input/output interface 794 is possible as well, and includes infrared, BLUETOOTH® wireless technology, 802.11a/b/g/n, cellular, ultra-wideband (UWB), ZigBee, or other radio frequency communication systems in some possible embodiments.

In this example embodiment, a display device 796, such as a monitor, liquid crystal display device, projector, or touch sensitive display device, is also connected to the system bus 764 via an interface, such as a video adapter 798. In addition to the display device 796, the computing device 750 can include various other peripheral devices (not shown), such as speakers or a printer.

When used in a local area networking environment or a wide area networking environment (such as the Internet), the computing device 750 is typically connected to the network through a network interface 1000, such as an Ethernet interface or WiFi interface. Other possible embodiments use other communication devices. For example, some embodiments of the computing device 750 include a modem for communicating across the network.

The computing device 750 typically includes at least some form of computer readable media. Computer readable media includes any available media that can be accessed by the computing device 750. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 750.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 7 is also an example of programmable electronics, which may include one or more such computing devices, and when multiple computing devices are included, such computing devices can be coupled together with a suitable data communication network so as to collectively perform the various functions, methods, or operations disclosed herein.

1. A processor comprising:
a plurality of control registers;
an instruction processing pipeline operationally coupled with the plurality of control registers, the instruction processing pipeline being configured to execute a plurality of machine-readable instructions based on respective information stored in the plurality of control registers; and
a pipeline flush control unit operationally coupled with the instruction processing pipeline, the pipeline flush control unit being configured to:
record, in response to the instruction processing pipeline completing execution of a first instruction, an indication of the first instruction, the first instruction being configured to write to a first control register of the plurality of control registers;
identify a second instruction in the instruction processing pipeline prior to completing execution of the second instruction;
determine, based on a set of predetermined criteria, whether the second instruction conflicts with the first instruction; and
if the second instruction is determined to conflict with the first instruction, initiate flushing of the instruction processing pipeline.

2. The processor of claim 1, wherein, if the second instruction is determined not to conflict with the first instruction, the instruction processing pipeline is configured to complete execution of the second instruction.

3. The processor of claim 1, wherein the second instruction is configured to write to a second control register of the plurality of control registers,
the pipeline flush control unit being further configured to:
record an indication of the second instruction;
identify a third instruction in the instruction processing pipeline prior to completing execution of the third instruction;
determine, based on the set of predetermined criteria, whether the third instruction conflicts with the first instruction or conflicts with the second instruction; and
if the third instruction is determined to conflict with the first instruction or the second instruction, initiate flushing of the instruction processing pipeline.

4. The processor of claim 3, wherein, if the third instruction is determined not to conflict with the first instruction or the second instruction, the instruction processing pipeline is further configured to complete execution of the third instruction.

5. The processor of claim 1, wherein the pipeline flush control unit includes an accumulator configured to store the indication of the first instruction and the indication of the second instruction.

6. The processor of claim 1, wherein the processor is configured to clear the accumulator in response to initiating flushing of the instruction processing pipeline.

7. The processor of claim 1, wherein the instruction processing pipeline includes, sequentially:
a fetch stage;
a decode stage;
an execute stage;
a memory stage; and
a writeback stage.

8. The processor of claim 1, wherein the instruction processing pipeline includes a RISC-V instruction processing pipeline.

9. A processor comprising:
a plurality of control registers (CRs);
an instruction processing pipeline operationally coupled with the plurality of CRs, the instruction processing pipeline being configured to execute a plurality of machine-readable instructions based on respective information stored in the plurality of CRs, the plurality of machine-readable instructions including a plurality of CR instructions and a plurality of non-CR instructions; and
a pipeline flush control unit operationally coupled with the instruction processing pipeline, the pipeline flush control unit being configured to:
record, in response to the instruction processing pipeline completing execution of a first instruction, an indication of the first instruction, the first instruction being a first CR instruction of the plurality of CR instructions;
identify a second instruction in the instruction processing pipeline prior to completing execution of the second instruction;
determine, based on a set of predetermined criteria, whether the second instruction conflicts with the first CR instruction; and
if the second instruction is determined to conflict with the first CR instruction, initiate flushing of the instruction processing pipeline.

10. The processor of claim 9, wherein, if the second instruction is determined not to conflict with the first instruction, the instruction processing pipeline is configured to complete execution of the second instruction.

11. The processor of claim 9, wherein the second instruction is a non-CR instruction of the plurality of non-CR instructions.

12. The processor of claim 9, wherein the second instruction is a second CR instruction of the plurality of CR instructions,
the pipeline flush control unit being further configured to:
record an indication of the second CR instruction;
identify a third instruction in the instruction processing pipeline prior to completing execution of the third instruction;
determine, based on the set of predetermined criteria, whether the third instruction conflicts with the first CR instruction or the second CR instruction; and
if the third instruction is determined to conflict with the first CR instruction or the second CR instruction, initiate flushing of the instruction processing pipeline.

13. The processor of claim 12, wherein, if the third instruction is determined not to conflict with the first CR instruction or the second instruction, the instruction processing pipeline is further configured to complete execution of the third instruction.

14. The processor of claim 12, where the third instruction is a non-CR instruction.

15. The processor of claim 9, wherein the pipeline flush control unit includes an accumulator configured to store the indication of the first CR instruction and the indication of the second CR instruction.

16. The processor of claim 9, wherein the processor is configured to clear the accumulator in response to initiating flushing of the instruction processing pipeline.

17. The processor of claim 9, wherein the instruction processing pipeline includes a RISC-V instruction processing pipeline.

18. A method of processing machine-readable instructions, the method comprising:
completing, in an instruction processing pipeline of a processor, execution of a first instruction of the machine-readable instructions;
determining, by the processor in response to completing the execution of the first instruction, that flushing of the instruction processing pipeline can be delayed;
recording an indication of the first instruction;
examining the instruction processing pipeline to identify a second instruction of the machine-readable instructions in the instruction processing pipeline prior to completing execution of the second instruction;
determining, based on a set of predetermined criteria, whether the second instruction conflicts with the first instruction; and
if the second instruction is determined to conflict with the first instruction, initiating flushing of the instruction processing pipeline.

19. The method of claim 18, wherein:
the first instruction is a control register (CR) instruction; and
the second instruction is a non-CR instruction.

20. The method of claim 18, wherein, if the second instruction is determined not to conflict with the first instruction, the method further comprises completing execution of the second instruction.

21. The method of claim 18, wherein:
the first instruction is a first control register (CR) instruction; and
the second instruction is a second CR instruction,
the method further comprising:
recording an indication of the second CR instruction;
identifying a third instruction of the machine-readable instructions in the instruction processing pipeline prior to completing execution of the third instruction;
determining, based on the set of predetermined criteria, whether the third instruction conflicts with the first CR instruction or conflicts with the second CR instruction; and
if the third instruction is determined to conflict with the first CR instruction or the second CR instruction, initiating flushing of the instruction processing pipeline.

22. The method of claim 21, wherein the third instruction is a non-CR instruction.

23. The method of claim 21, wherein, if the third instruction is determined not to conflict with the first CR instruction or the second CR instruction, the method further comprises completing execution of the third instruction.

24. A processor comprising:
a plurality of control registers;
an instruction processing pipeline operationally coupled with the plurality of control registers, the instruction processing pipeline being configured to execute a plurality of machine-readable instructions based on respective information stored in the plurality of control registers; and
a pipeline flush control unit operationally coupled with the instruction processing pipeline, the pipeline flush control unit and the instruction processing pipeline being configured to:
record, in response to the instruction processing pipeline completing execution of a first instruction, an indication of the first instruction, the first instruction being configured to write to a first control register of the plurality of control registers;
identify a second instruction in the instruction processing pipeline prior to completing execution of the second instruction;
determine, based on a set of predetermined criteria, that the second instruction does not conflict with the first instruction;
complete execution of the second instruction;
identify a third instruction in the instruction processing pipeline;
determine, based on the set of predetermined criteria, that the third instruction conflicts with the first instruction; and
in response to the determination that the third instruction conflicts with the first instruction, initiate flushing of the instruction processing pipeline prior to completing execution of the third instruction.
